(19) United States
(12) Patent Application Publication
(10) Pub. No.: US 2013/0207381 A1
(43) Pub. Date: Aug. 15, 2013

(54) FLUID COUPLING

(71) Applicants: Leigh Wayne Morrison, Footscray (AU); Kon Lai, Lalor (AU); Matthew Paul King, Ringwood (AU)

(72) Inventors: Leigh Wayne Morrison, Footscray (AU); Kon Lai, Lalor (AU); Matthew Paul King, Ringwood (AU)

(73) Assignee: Australasian Steel Products PTY Ltd, Footscray, Victoria (AU)

(21) Appl. No.: 13/808,866

(22) PCT Filed: Jul. 5, 2011
(86) PCT No.: PCT/AU11/00839

§ 371 Date: Feb. 28, 2013

(30) Foreign Application Priority Data
Jul. 5, 2010 (AU) 2010902972

(51) Int. Cl. F16L 37/12

(52) U.S. Cl. CPC F16L 37/12
USPC 285/82

(57) ABSTRACT

A female coupling member releasably interconnectable with a male coupling member to form a fluid coupling is disclosed. The male coupling member has an inlet end, and an outlet end connectable to a fluid flow line. The female coupling member includes a tubular coupling body having an inlet end for axially receiving the inlet end of the male coupling member, and an outlet end connectable to a fluid flow line. The female coupling member also includes a locking element operable between a release position where the locking element is remote from the male coupling member when received within the female coupling member. A release member moves the locking element between the release position and the locking position. The female coupling member has a fastening element which is releasably securable to the release member preventing the release member unintentionally moving to the displacement position when secured to the release member.

### FIELD OF THE INVENTION

The present invention generally relates to a female coupling member and a fluid coupling formed using this female coupling member. The invention is particularly applicable to fluid couplings which incorporate quick connection and release mechanisms between male and female coupling members interconnecting fluid flow lines and it will be convenient to hereinafter disclose the invention in relation to that exemplary application.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

A number of quick connection and release fluid couplings have been developed. In most existing fluid couplings, a male coupling member is releasably connected to a female coupling member upon insertion of the male member into the female member. A locking mechanism is provided to relatively lock the male and female members. The locking mechanism can include a series of balls, one or more split rings or shafts which engage in aligned grooves or recesses in the male and female members. Locking release means are also provided to release the locking elements from the respective grooves or recesses and thus allow disconnection of the male member from the female member.

Most of these fluid couplings require a number of interconnected and interactive parts to function. The componentary of these fluid couplings can be complex. In some cases, the componentary can be prone to fouling under certain conditions.

It is desirable to provide an alternate fluid coupling or a coupling member thereof to the prior fluid couplings discussed above.

### SUMMARY OF THE INVENTION

According to a first aspect of the present invention, there is provided a female coupling member that is releasably interconnectable with a male coupling member to form a fluid coupling, the male coupling member having an inlet end, and an outlet end connectable to a fluid flow line, the female coupling member including:
a tubular coupling body defining an axially extending passage having an longitudinal axis extending therethrough, the coupling body having an inlet end for axially receiving the inlet end of the male coupling member, and an outlet end connectable to a fluid flow line;
a locking element operable between a release position where the locking element is remote from the male coupling member when received within the female coupling member and a locking position in which the locking element exerts a retaining influence between the male coupling member and female coupling member when the male coupling member is received within the female coupling member, the locking element including a plurality of locking sub-elements, such that in the locking position the locking sub-elements engage the male coupling member and in the release position the locking sub-elements are remote from the male coupling member, the locking sub-elements being interconnected by one or more connector members;
a release member for moving the locking element between the release position and the locking position, the release member being movable between a secure position where the release member is positioned relative to the locking element that allows the locking element to remain in its locking position, and a displacement position where the release member has moved the locking element into its release position; and
a fastening element releasably securable to the release member, the fastening element preventing the release member unintentionally moving to the displacement position when secured to the release member.

The connection and release mechanism linking the female coupling member and male coupling member includes a locking element that is movable between a release position and locking position by actuation of a release member. The release member is movable between a secure position and a displacement position to actuate the locking element. This movement of the release member can be impeded by placing the releasably securable fastening element on or around the release member. In such an arrangement, the locking element can therefore only be moved to the release position by removing the fastening element from or around the release member. The release member can then be manually actuated by a user to move the locking element.

The locking element preferably releasably fastens the male connector to the female connector within the axially extending passage of the coupling body. For this function, the locking element can have a substantially radial movement relative to the longitudinal axis when moving between the release position and locking position. This radial movement can comprise the radial movement of one or more separate locking element components, circumferential contraction of an annular member of the locking element or a combination thereof.

In one embodiment, the locking element includes a plurality of locking sub-elements.

In the locking position, the locking sub-elements engage the male coupling member. In the release position, the locking sub-elements are remote from the male coupling member. Each of the sub-elements is preferably circumferentially spaced apart relative to the longitudinal axis of the coupling body. Furthermore, each of the sub-elements preferably move radially between the release position and the locking position to circumferentially contract the locking element around the male coupling member when that male coupling member is received in the axially extending passage. To accommodate these sub-elements, the coupling body can include a circumferential retaining recess for receiving the locking sub-elements when in their release position. In some embodiments, the circumferential retaining recess may include an opening through the coupling body through which the locking sub-elements can be inserted and removed from the retaining recess.

The locking element preferably includes a plurality locking segments that are circumferentially spaced within the retaining recess. The sub-elements of the locking element can have any suitable shape or configuration. Suitable sub-element shapes include (but are not limited to) an elongate arcuate body, a spherical body, a cylindrical body, a rectangular body, a cubic body, other polygon body or the like. In other forms, the locking sub-elements may have spherical, cylindrical or generally polygon forms. Each locking segment preferably moves generally radially relative to the longitudinal axis between the release position and the locking position.

The locking sub-elements are interconnected, for example by a flexible member, resilient member, clip or the like. Any number of interconnection elements is possible, such as chains, hinges, pivot joints, flexible cords, resilient wire, circlips, springs or the like. In a preferred form, the locking sub-elements comprise a plurality of interconnected shear bodies connected by one or more connector members. In some forms, each shear body may include a discrete connector section which forms a connection with an adjacent shear body. Each connector member includes a flexible and/or resilient member integrally joining adjacent shear bodies. The flexible and/or resilient member can comprise at least one of a flexible cord, a resilient body, wire, coil, spring or a chain. In one embodiment, each sub-element is threaded on a common flexible cord. In another embodiment, the locking sub-elements form generally cylindrical or polygon shear bodies, connected on a solid wire connection member. In one exemplary form, the locking element is a clip, for example a resilient clip, and more preferably a circlip.

In some forms, each sub-element can include a chamfer configured to cooperate with a complementary chamfer located in a groove housing the shear element in a coupling. The chamfer and complementary chamfer can be any suitable shape.

The locking element can include a biasing means that biases the locking element towards the locking position. The biasing means can be any suitable component or device such as a spring, resilient element or similar. In one embodiment, the biasing element is an annular spring seated around the circumference of the locking element. Where the locking element comprises a plurality of locking sub-elements, the annular spring is preferably seated around each of the sub-elements and biases each of the sub-elements towards their locking position.

The female coupling member can be formed from a single unitary body in some embodiments. In other forms, female coupling member can be formed from two or more sections. These sections may be interlocking or more preferably configured to be releasably connectable.

The release member is provided on the female coupling member to move the locking element between the release position and the locking position. To accomplish this movement, the release member preferably engages at least a portion of the locking elements when moving between its secure position and displacement position. The release member therefore preferably includes an engagement surface that engages the locking elements. In one embodiment, the release member includes a release sleeve extending coaxially relative to the longitudinal axis between the female coupling member and male coupling member when interconnected. The release sleeve includes an abutment rim which functions as the engagement surface that engages the locking element. Here, movement of the release member towards its displacement position causes the abutment rim to engage a portion of the locking element and radially move the locking element relative to the longitudinal axis towards the release position. The abutment rim can have any suitable shape, but preferably includes a ramp or sloped surface. Each of the locking elements also preferably has a cooperating inclined surface which the abutment rim engages to radially move the locking elements relative to the longitudinal axis towards the release position.

The release member is preferably located on the coupling body of the female member. In one embodiment, the release sleeve of the release member is located within the axially extending passage of the coupling body. In this form, the release sleeve moves longitudinally within the axially extending passage. In some embodiments, the release sleeve is releasably fitted within the axially extending passage. In other embodiments, at least a portion of the release sleeve is retained within the coupling body. This can be accomplished in some embodiments through the inclusion of an annular groove in an inner surface of the release sleeve facing the coupling body, the annular groove housing a retaining member. The retaining member can be any member that secures the release sleeve within the axially extending passage. For example, in one form the retaining member includes a retaining ring secured within an annular groove in a portion of the coupling body of the female coupling member.

The release member moves between the secure position and displacement position when actuating the locking element. In the secure position, the release member can be remote from the locking element, adjacent to the locking element and/or abutting or in engagement with the locking element. In each case, the release member is in a position which does not substantially move or displace the locking element from its locking position. In contrast, when the release member is in the displacement position, it has moved the locking element into its release position.

Movement of the release member between the secure position and displacement position can include any number of motions including rotational, translational, pivoting or similar. Preferably, the movement of the release member between the secure position and displacement position is in a direction generally parallel to the longitudinal axis of the coupling body. With this type of motion, the lock release member is preferably slidably carried on the tubular coupling body, and the release member slidably moves along the tubular coupling body between the secure position and displacement position.

The fastening element preferably impedes movement of the release member from the secure position to the displacement position. In one embodiment, a portion of the fastening element is configured to be seated between the release member and a portion of the coupling body to prevent unintentional movement of the release member along the longitudinal axis of the coupling body. Where the release member slidably moves along the tubular coupling body, this portion is preferably positioned to prevent sliding movement of the release member.

The coupling body and release member can have any number of cooperating configurations to prevent sliding movement of the release member. In one form, the release member includes an annular flange section which is manually engageable for movement of the release member along the longitudinal axis of the coupling body.

The coupling body also preferably includes an annular shoulder located axially closer along the longitudinal axis to the locking element than the annular flange section of the release member. The fastening element can then be received between the annular shoulder and annular flange section of the release member to prevent unintentional movement of the release member along the longitudinal axis of the coupling. In this embodiment, the fastening element preferably comprises a releasably securable clip, which is securable around a portion of the release member. However, it is to be appreciated that other fastening devices such as pegs, bands, pins or similar could equally be used.

The coupling body can have a number of configurations. In one embodiment, the coupling body comprises a single body which carries the locking element and release member. In other embodiments, the coupling body includes a nut portion rotatably connected to a main coupling body. The nut portion typically includes the locking element and release member.

A fluid and/or pressure tight seal can be formed between the male coupling member and female coupling member using a seal positioned between two adjacent sections of these coupling members. In one embodiment, the female coupling member further includes at least one annular seal located within the axially extending passage of the coupling body. The annular seal is positioned to sealingly engage the female coupling member and the tubular male coupling member when that male coupling member is received within the axially extending passage of the coupling body. The annular seal is preferably carried by the female coupling member within the axially extending passage. In one embodiment, the annular seal is seated within an annular groove located in the coupling body, preferably the axially extending passage thereof, of the female coupling member.

According to a second aspect of the present invention, there is provided a fluid coupling for interconnecting fluid flow lines, including:
a tubular male coupling member having an inlet end, and an outlet end connectable to a fluid flow line; and
a tubular female coupling member according to the first aspect of the present invention.

The tubular male coupling member preferably includes a tubular coupling body having a radial groove for receiving the locking element to provide a tight connection between the tubular male coupling member and female coupling member.

The female coupling member according to the present invention and related fluid coupling can be used in high pressure, and low pressure applications. As can be appreciated, the materials for the constituent parts of the coupling member and fluid coupling can be selected to meet the required pressure and mechanical specification for a required application. For example, in a low pressure application, some or all of the parts of the female coupling member and male coupling member could comprise a plastic material. Whilst in high pressure applications, the parts of the female coupling member and male coupling member could be selected from metals, ceramics or the like.

### BRIEF DESCRIPTION OF THE DRAWINGS

The present invention will now be described with reference to the figures of the accompanying drawings, which illustrate a particular preferred embodiment of the present invention, wherein:

FIG. 1 is a perspective view of one embodiment of the fluid coupling according to the present invention.

FIG. 2 is a perspective view of the fluid coupling shown in FIG. 1 with the female and male coupling members disconnected.

FIG. 3 is a longitudinal cross-sectional view of the fluid coupling of FIG. 1 in a locked state.

FIG. 4 is a longitudinal cross-sectional view of the fluid coupling of FIG. 1 with the securing clip removed and the release member moved between the locked position and displacement position.

FIG. 5 is a longitudinal cross-sectional view of the fluid coupling of FIG. 1 with the release member moved to a displacement position.

FIG. 6 is a perspective view of another embodiment of the fluid coupling according to the present invention.

FIG. 7 is a longitudinal cross-sectional view of the fluid coupling of FIG. 6 in a locked state.

FIG. 8 is an isometric view of an alternate locking element that can be used in the fluid couplings shown in FIGS. 1 to 7.

### DETAILED DESCRIPTION

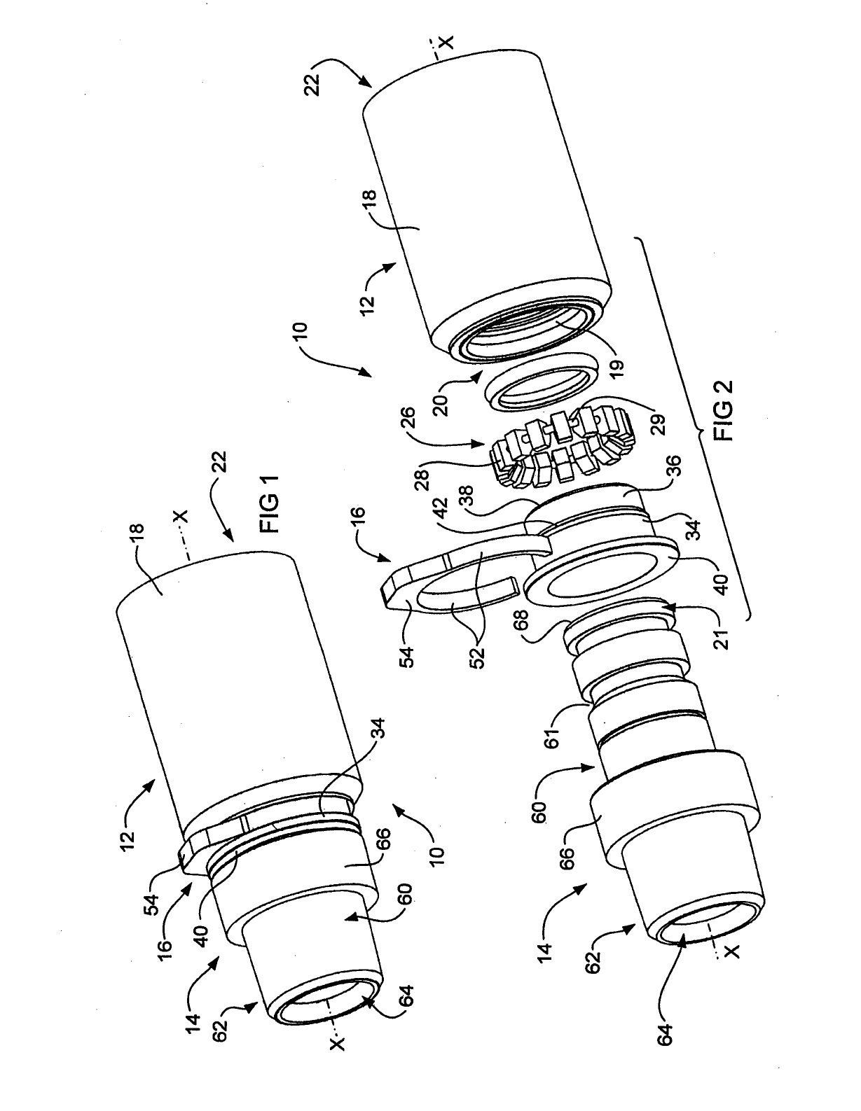

Referring to FIGS. 1 and 2, there is shown a fluid coupling 10 according to one preferred embodiment of the present invention. As best shown in FIG. 1, the fluid coupling 10 comprises three separable components, being a female coupling member 12, male coupling member 14 and retaining clip 16. The female coupling member 12 is releasably interconnectable with the male coupling member 14 using a quick connection and release mechanism (described below). The retaining clip 16 fastens over a portion of the female coupling member 12 to prevent unintentional disconnection of the female coupling member 12 and the male coupling member 14.

The illustrated female coupling member 12 includes a tubular female coupling body 18 having a circular outer cross-sectional shape. However, it should be appreciated that a variety of other outer cross-sectional shapes could be used. The tubular female coupling body 18 includes an axially extending passage 19 therethrough having an inlet 20 for receiving an inlet end 21 of the male coupling member 14, and an outlet 22 connectable to a fluid flow line or other fluid fitting. The axially extending passage 19 has a longitudinal axis X-X extending therethrough.

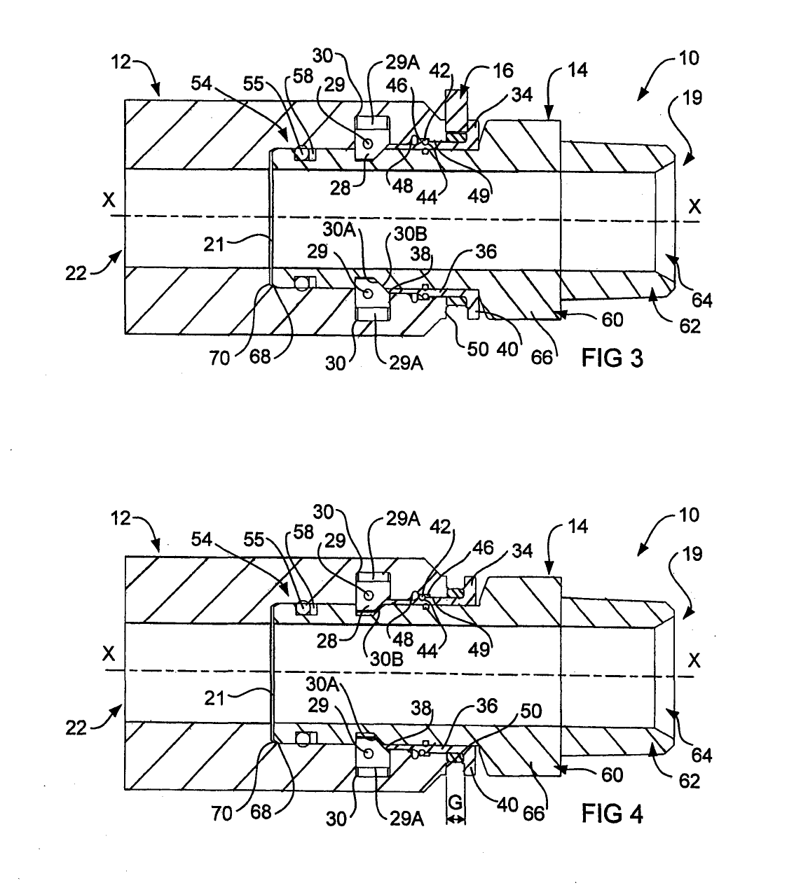

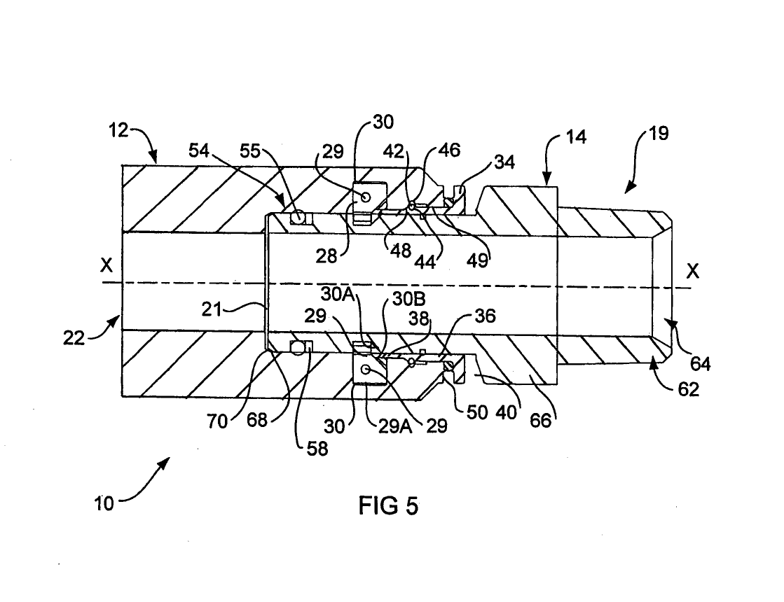

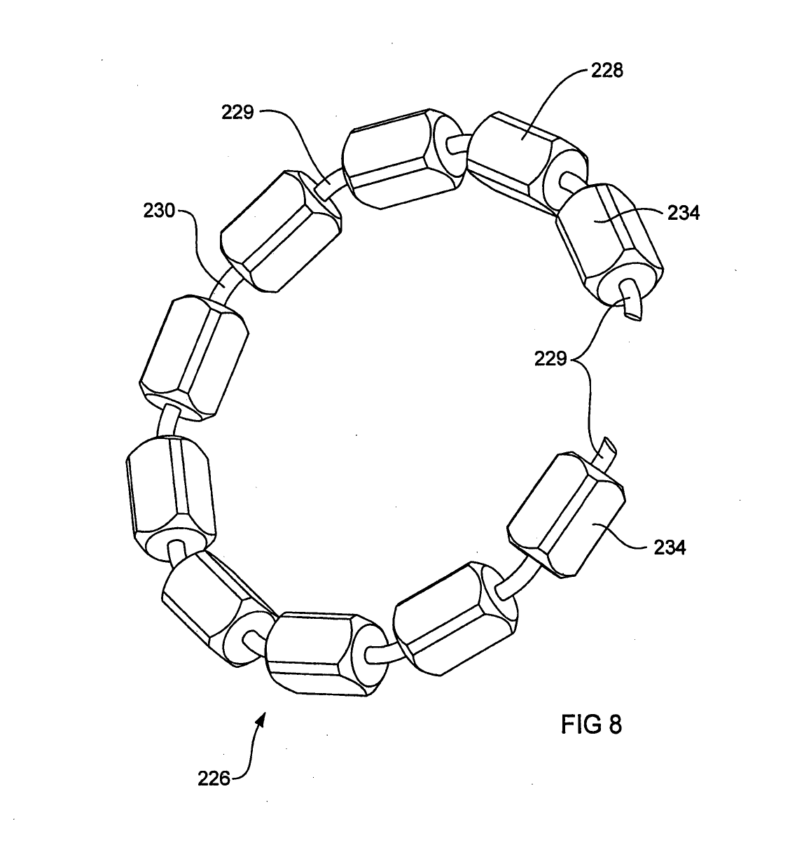

The connection and release mechanism between the female coupling member 12 and male coupling member 14 is carried by the female coupling member 12. This mechanism includes a locking element 26 comprising a series of locking segments 28 interconnected, fixed or attached on a central flexible, resilient cord 29. It should be appreciated that other forms of the locking element 26 are possible, for example a clip or circlip 226 shown in FIG. 8. Each of the illustrated locking segments 28 has a polygon cross-section (see FIGS. 3 to 5). Each of the illustrated locking segments 28 also have a chamfer 30A which cooperate with a complementary chamfer 30B located in an annular retaining recess 61 which receives the locking element 26 in the male coupling member 14. Each of the locking segments 28 are circumferentially spaced within an annular retaining recess 30 (best shown in FIGS. 3 to 6) formed in an inner wall of the female coupling body 18. Each locking segment 28 can move generally radially relative to the longitudinal axis X-X between a release position (shown in FIG. 5) where the locking segments 28 are remote from the male coupling member 14 when received within the axially extending passage 19 and a locking position (shown in FIG. 3) in which each locking segment 28 engages the male coupling member 14 when the male coupling member 14 is received within the axially extending passage 19. The locking element 26 includes an annular spring 29A (best shown in FIGS. 3 to 5) seated around the circumference of the locking element 26 that biases the locking segments 28 towards the locking position.

The connection and release mechanism also includes a release member 34 carried by the female coupling member 12 for moving the locking element 26 between the release position and the locking position. As best shown in FIGS. 3 to 5, the release member 34 includes a tubular release sleeve 36 coaxially extending within the axially extending passage 19 relative to the longitudinal axis X-X between the female coupling body 18 and male coupling member 14 when interconnected. A ramped abutment rim 38 is provided at the distal end of the release sleeve 36 for engaging the locking segments 28. The release member 34 is slidably carried within the female coupling body 18. The release member 34 slidably moves along the longitudinal axis X-X of the female coupling body 18 between a secure position (shown in FIG. 3) where the release member 34 is adjacent to the locking segments 28 but not actuating the segments 28 and a displacement position (shown in FIG. 5) where the release member 34 has moved the locking segments 28 into their respective release positions. The release member 34 also includes an annular release flange 40 at one end which is manually engageable for movement of the release member 34 along the longitudinal axis X-X of the female coupling body 18. A user can manually actuate the release flange 40 using their fingers or using a tool such as a screwdriver (not illustrated in the Figures).

The release sleeve 36 is retained within the axially extending passage 19 using a retaining ring 42 secured within an annular groove 44 in a portion of the release sleeve 36. The female coupling body 18 of the female coupling member 12 also includes an annular groove 46 in an inner surface of the release sleeve 36 facing the coupling body in which the retaining ring 42 is seated. Movement of the release member 34 along the longitudinal axis X-X of the female coupling body 18 is restricted by the longitudinal extent of the annular groove 46 between the annular edges 48, 49 of the annular groove 46.

The female coupling body 18 includes an annular shoulder 50 located axially closer to the locking element 26 along the longitudinal axis X-X than the release flange 40 of the release member 34. A longitudinal gap G (FIG. 4) is present between the annular shoulder 50 of the female coupling body 18 and the release flange 40 of the release member 34 when the release member 34 is in its secure position (as shown in FIG. 3).

The retaining clip 16 is configured to be received in the longitudinal gap G, between the annular shoulder 50 of the female coupling body 18 and the release flange 40 of the release member 34. As best shown in FIG. 2, the retaining clip 16 comprises an annular clip having two arcuate legs 52 and a handle 54. The arcuate legs 52 fit around the outside of the release sleeve 36 between the annular shoulder 50 of the female coupling body 18 and the release flange 40 of the release member 34. The tight fit of retaining clip 16 in this location is designed to prevent unintentional movement of the release member 34 along the longitudinal axis of the female coupling body 18 towards its displacement position.

The male coupling member 14 comprises a tubular male coupling body 60 having an inlet end 21 which is receivable within the inlet passage 19 of the female coupling member 12, and an outlet end 62 connectable to a fluid flow line or other fluid fitting. A fluid flow passage 64 is defined between the inlet 21 and outlet 62, and when fastened within the axially extending passage 19 (for example in FIGS. 3 to 5) extends along the longitudinal axis X-X. The male coupling body 60 has a cooperative configuration with the female coupling member 12 to allow the male coupling member 14 to be tightly fastened within the axially extending passage 19 of the female coupling member 12. The tubular male coupling member 14 includes a radial groove 61 in the male coupling body 60 for receiving the locking segments 28 of the locking element 26 to assist fastening the male and female coupling members together.

A seal arrangement 54 comprising an o-ring seal 55 seated within a retaining recess 58 formed in male coupling member 14 near the inlet 21. Each of the seal 55 is carried by the male coupling member 14 within the retaining recess 58. The seal arrangement 54 can also be carried by the female coupling 12 in a similar arrangement. The o-ring 55 are positioned to sealingly engage the female coupling member 12 and the male coupling member 14 when the male coupling member 14 is received within the axially extending passage 19 of the female coupling body 18.

The outlet end 62 of the male coupling body 60 includes a radially extending annular flange 66 which is proximate the release flange 40 of the release member 34 when the male coupling member 14 is fully inserted within the axially extending passage 19 of the female coupling member 12. The inlet end 21 of the male coupling member 14 also includes a sloped or ramped edge 68 which can abut a sloped surface on an inner shoulder 70 of the female coupling body 18. The shoulder 70 provides a stop which limits the extent of insertion of the male coupling body 60 within the axially extending passage 19.

FIGS. 3 to 5 provide cross-sectional views of the fluid coupling 10 in various stages of disassembly.

FIG. 3 shows the fluid coupling 10 with the male coupling member 14 secured within the axially extending passage 19 of the female coupling member 12. In this configuration, the female coupling member 12 and male coupling member 14 are secured together with the locking element 26 in its locking position and the release member 34 held its secure position by the retaining clip 16 fastened between the annular shoulder 50 of the female coupling body 18 and the release flange 40 of the release member 34. The retaining clip 16 secured in this position prevents unintentional movement of the release member 34 towards its displacement position.

The male coupling member 14 is extracted from the female coupling member 12 by removing the retaining clip 16 from around the release member 34, as shown in FIG. 4. The release member 34 is then slid longitudinally relative to the axis X-X along the female coupling body 18, generally through manual manipulation of the release flange 40 towards its displacement position (as shown in FIG. 5). This movement causes the ramped abutment rim 38 of the release sleeve 36 to displace each locking segment 28 generally radially relative to the longitudinal axis X-X from their locking position to their release position where the locking segments 28 are remote from the male coupling member 14 (FIG. 5). The male coupling member 14 can then be removed from the axially extending passage 19.

The male coupling member 14 and female coupling member 12 can be connected by simply inserting the inlet end 21 of the male coupling member 12 into the inlet end 20 of the female coupling member 12 to its full extent as shown in FIG. 4. The retaining clip 16 is then fastened between the annular shoulder 50 of the female coupling body 18 and the release flange 40 of the release member 34 to prevent unintentional movement of the release member 34 towards its displacement position.

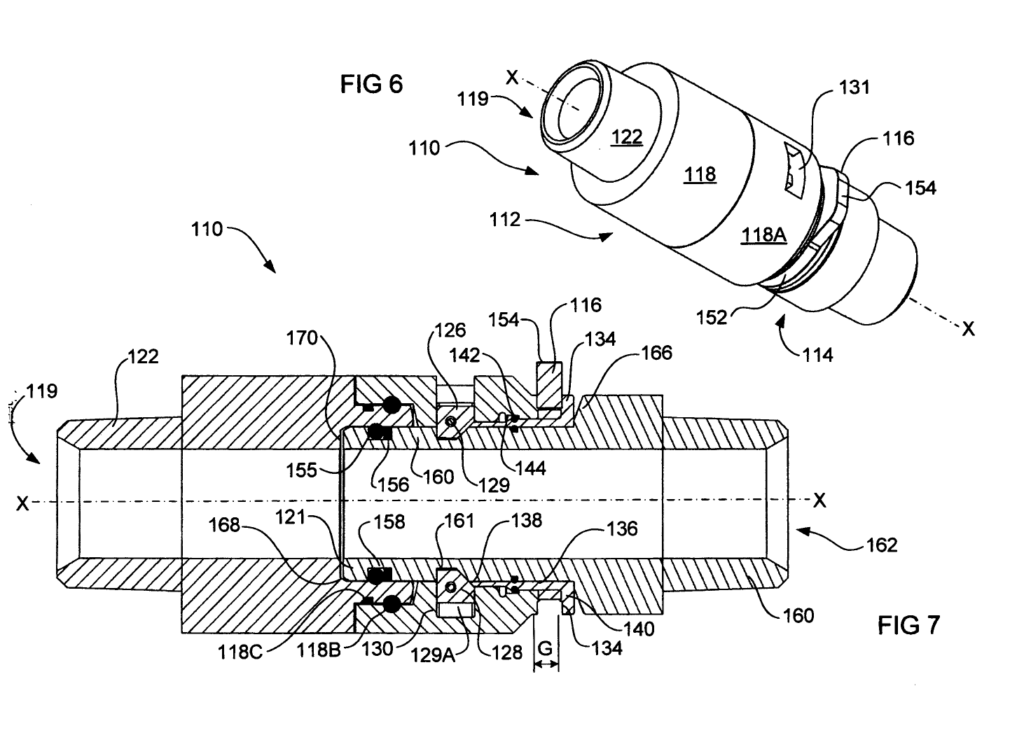

FIGS. 6 and 7 illustrate a further embodiment of a fluid coupling 110 according to another preferred embodiment of the present invention. The illustrated fluid coupling 110 has a similar configuration to the fluid coupling 10 shown in FIGS. 1 to 5. Accordingly, like reference numbers from the fluid coupling 10 have been used for similar features for the fluid coupling 110 plus 100.

The fluid coupling 110 also comprises three separable components, being a female coupling member 112, male coupling member 114 and retaining clip 116. The female coupling member 112 is releasably interconnectable with the male coupling member 114 using a similar quick connection and release mechanism as described for the previous embodiment. Again, the retaining clip 116 fastens over a portion of the female coupling member 112 to prevent unintentional disconnection of the female coupling member 112 and the male coupling member 114.

In this embodiment, female coupling member 112 includes a tubular female coupling body 118 which includes at one end an outlet 122 which is connectable to a fluid conduit, pipe, fitting or the like and at the other end a rotatably connected nut 118A which substantially receives an inlet end 121 of the male coupling member 114. The nut 118A is rotatably fastened onto the tubular female coupling body 118 through an annular wire or ring 1186 which is held in cooperating annular grooves in the coupling body 118 and nut 118A. A dust seal 118C is also provided. The female coupling member 112 includes an axially extending passage 119 therethrough having an inlet 120 for receiving an inlet end 121 of the male coupling member 114, and an outlet 122 connectable to a fluid flow line or other fluid fitting. The axially extending passage 119 has a longitudinal axis X-X extending therethrough.

The connection and release mechanism between the female coupling member 112 and male coupling member 114 is carried by the female coupling member 112 in the nut 118A portion thereof. Once again, this mechanism includes a locking element 126 comprising a series of locking segments 128 that are circumferentially spaced within an annular retaining recess 130 formed in an inner wall of the female coupling nut 118A. Again, each locking segment 128 is a polygonal body (FIG. 7) interconnected, fixed or attached by a central flexible cord or resilient member 129. Again, it should be appreciated that other forms of the locking element 26 are possible, for example a clip or circlip 226 shown in FIG. 8. The annular retaining recess 130 includes a slot 131 which allows the segments 128 to be inserted or removed therethrough. When the locking segment 128 are located annular retaining recess 130, each locking segment 128 can move generally radially relative to the longitudinal axis X-X between a release position and a locking position as described above for the previous embodiment. The locking element 126 can also include an annular spring 129A seated around the circumference of the locking element 126 that biases the locking segments 128 towards the locking position.

A release member 134 for moving the locking element 126 between the release position and the locking position is slidably carried by the female coupling member 112. Again, the release member 134 includes a tubular release sleeve 136 coaxially extending within the axially extending passage 119 relative to the longitudinal axis X-X between the female coupling body 118 and male coupling member 114 when interconnected. A ramped abutment rim 138 is provided at the release sleeve's 136 distal end for engaging the locking segments 128. The release member 134 also includes an annular release flange 140 at one end which is manually engageable for movement of the release member 134 along the longitudinal axis X-X of the female coupling body 118. The release sleeve 136 is retained within the axially extending passage 119 using a retaining ring 142 secured within an annular groove 144 in a portion of the nut 118A of the female coupling member 112.

The female coupling body 118 includes an annular shoulder 150 located axially closer to the locking element 126 along the longitudinal axis X-X than the release flange 140 of the release member 134. A longitudinal gap G is present between the annular shoulder 150 of the female coupling body 118 and the release flange 140 of the release member 134 when the release member 134 is in its secure position.

The retaining clip 116 is configured to be received in the longitudinal gap G, with a tight fit between the annular shoulder 150 of the female coupling body 118 and the release flange 140 of the release member 134. Again, the retaining clip 116 comprises an annular clip having two arcuate legs 152 and a handle 154.

O-ring seal 155 and O-ring backup seal 156 are seated within a retaining recess 158 formed in an inner wall of the female coupling body 118 near the outlet 122. The o-ring 155 and backup 156 are positioned to sealingly engage the female coupling member 112 and the male coupling member 114 when the male coupling member 114 is received within the axially extending passage 119 of the female coupling body 118.

The male coupling member 112 comprises a tubular male coupling body 160 having an inlet end 121 which is receivable within the inlet passage 119 of the female coupling member 112, and an outlet end 162 connectable to a fluid flow line or other fluid fitting. The male coupling body 160 has a cooperative configuration with the female coupling member 112 to allow the male coupling member 114 to be tightly fastened within the axially extending passage 119 of the female coupling member 112. The tubular male coupling member 114 includes a radial groove 161 in the male coupling body 160 for receiving the locking segments 128 of the locking elements 126 to assist fastening the male and female coupling members together.

The inlet end 121 of the male coupling member 114 also includes sloped or ramped edge 168 which can abut a sloped surface on an inner shoulder 170 of the female coupling body 118. The shoulder 170 provides a stop which limits the extent of insertion of the male coupling body 160 within the axially extending passage 119. The edge 168 of the male coupling body 160 also provides a ramp over which the locking segments 128 of the locking element 126 can ride when the male coupling body 160 is inserted within the axially extending passage 119.

The locking elements 26 and 126 of fluid couplings 10 and 110 can comprise any suitable segmented locking ring. It should be appreciated that such locking rings could comprise any of the shear elements taught in the Applicants co-pending international application “Shear elements for a coupling” having an international filing date of 26 May 2011, the disclosure of which is taken to be incorporated herein by this reference.

One suitable locking element 226 of this type is shown in FIG. 8. The locking element 226 includes a plurality of spaced apart shear bodies 228 connected on a resilient wire connector body 229, forming a clip type arrangement. Each shear body 228 is fixedly connected around and to the wire connector body 229. This may be a weld, adhesive or other fixed connection. In a preferred form, each shear body 228 is crimped around and to the wire connector body 229. This results in each shear body 228 being spaced apart along that integral connector body 229. Discrete connector sections 230 are therefore formed between the respective connections between each shear body 228.

In use, the locking element 226 can be inserted into the annular retaining recess 130 of the fluid coupling 110 shown in FIGS. 6 and 7. The shear bodies 228 move between a locking position and release position through radial contraction/compression of the locking element. It should be appreciated that the shear elements 228 on the distal ends 234 of the locking element may have greater radial movement between a locking position and release position than the other shear elements 228 in the locking element.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1-25. (canceled)

26. A female coupling member, releasably interconnectable with a male coupling member to form a fluid coupling, the male coupling member having an inlet end, and an outlet end connectable to a fluid flow line, the female coupling member comprising:
a tubular coupling body defining an axially extending passage having an longitudinal axis extending therethrough, the coupling body having an inlet end for axially receiving the inlet end of the male coupling member, and an outlet end connectable to a fluid flow line;
a locking element operable between a release position where the locking element is remote from the male coupling member when received within the female coupling member and a locking position in which the locking element exerts a retaining influence between the male coupling member and female coupling member when the male coupling member is received within the female coupling member, the locking element comprising a plurality of locking sub-elements, such that in the locking position the locking sub-elements engage the male coupling member and in the release position the locking sub-elements are remote from the male coupling member, the locking sub-elements being interconnected by one or more connector members;
a release member for moving the locking element between the release position and the locking position, the release member being longitudinally movable in a direction along the longitudinal axis of the coupling body between a secure position where the release member is in a position relative to the locking element that allows the locking element to remain in its locking position, and a displacement position where the release member has moved the locking element into its release position; and
a fastening element releasably securable to the release member, the fastening element having a portion configured to be seated between the release member and a portion of the coupling body to prevent unintentional movement of the release member along the longitudinal axis of the coupling body to the displacement position when secured to the release member.

27. A female coupling member according to claim 26, wherein each connector member comprises a flexible and/or resilient member integrally joining adjacent sub-element comprising at least one of a flexible cord, a resilient body, wire, coil, spring or a chain.

28. A female coupling member according to claim 26, wherein the locking sub-elements comprise a plurality of locking segments circumferentially spaced within the retaining recess, each locking segment moving generally radially relative to the longitudinal axis between the release position to the locking position.

29. A female coupling member according to claim 26, wherein the locking element comprises a clip, preferably a circlip.

30. A female coupling member according to claim 26, wherein the locking element comprises biasing means biasing the locking element towards the locking position;the biasing element preferably being an annular spring seated around the circumference of the locking element.

31. A female coupling member according to claim 26, wherein the locking element has a substantially radial movement relative to the longitudinal axis between the release position and locking position.

32. A female coupling member according to claim 26, wherein the coupling body comprises a circumferential retaining recess in which the locking sub-elements are received when in the release position; the circumferential retaining recess preferably comprising an opening through the coupling body through which the locking sub-elements can be inserted and removed from the retaining recess.

33. A female coupling member according to claim 26, wherein the release member is operable to engage the locking elements to move the locking elements to the release position.

34. A female coupling member according to claim 26, wherein the release member comprises a release sleeve extending coaxially relative to the longitudinal axis between the female coupling member and male coupling member when interconnected, the release sleeve having an abutment rim that engages the locking elements when the release sleeve moves the locking elements towards the release position.

35. A female coupling member according to claim 34, wherein the abutment rim comprises a ramp or sloped surface.

36. A female coupling member according to claim 34, wherein each of the locking elements has a cooperating inclined surface with which the abutment rim engages to radially move relative to the longitudinal axis the locking elements towards the release position.

37. A female coupling member according to claim 34, wherein the release sleeve comprises an annular groove in an inner surface facing the coupling body, the annular groove housing a retaining member that retains the release member with the female coupling member during movement of the release member.

38. A female coupling member according to claim 37, wherein the retaining member comprises a retaining ring secured within an annular groove in a portion of the coupling body of the female coupling member.

39. A female coupling member according to claim 26, wherein the release member comprises an annular flange section which is manually engageable for movement of the release member along the longitudinal axis of the coupling body.

40. A female coupling member according to claim 39, wherein the coupling body comprises an annular shoulder located axially closer along the longitudinal axis to the locking element than the annular flange section of the release member, the fastening element received between the annular shoulder and annular flange section of the release member to prevent unintentional movement of the release member along the longitudinal axis of the coupling.

41. A female coupling member according to claim 26, wherein the coupling body comprises a nut portion rotatably connected to a main coupling body, the nut portion comprising the locking element and release member.

42. A female coupling member according to claim 26, wherein the fastening element comprises a releasably securable clip, which is securable around a portion of the release member.

43. A female coupling member according to claim 26, further comprising at least one annular seal located within the axially extending passage of the coupling body, the annular seal positioned to sealingly engage the female coupling member and the tubular male coupling member when that male coupling member is received within the axially extending passage of the coupling body; the annular seal preferably being seated within an annular groove located in the coupling body of the female coupling member.

44. A fluid coupling for interconnecting fluid flow lines, comprising:
a tubular male coupling member having an inlet end, and an outlet end connectable to a fluid flow line; and
a tubular female coupling member according to claim 26.

45. A fluid coupling according to claim 44, wherein the tubular male coupling member comprises a tubular coupling body that includes a radial groove for receiving the locking element.
